(19) United States
(12) Patent Application Publication
(10) Pub. No.: US 2016/0308811 A1
(43) Pub. Date: Oct. 20, 2016

(54) Communication System Invite Mechanism

(71) Applicant: Microsoft Technology Licensing, LLC, Redmond, MA (US)

(72) Inventors: Onur Cinar, Sunnyvale, CA (US); Vijay Chandrasekaran, Sunnyvale, CA (US); Daniel James Chastney, Sunnyvale, CA (US)

(21) Appl. No.: 14/690,080

(22) Filed: Apr. 17, 2015

(51) Int. Cl. H04L 12/58; H04L 12/24; H04L 29/08

(52) U.S. Cl. CPC H04L 51/18; H04L 67/34; H04L 67/02; H04L 67/18; H04L 41/22

(57) ABSTRACT

A user terminal comprising: a display; a processor configured to run a communication client application for establishing communication with at least one further user terminal over at least one communication network, wherein the client application is configured to: identify based on at least one search performed by the communication client application, at least one search result that is to be displayed on the display, each search result associated with a further user terminal; determine for each of the at least one search result, whether the further user terminal comprises the client application; and display the at least one search result, and for each further user terminal not comprising the client application, the client application is configured to further display a selectable input enabling transmission of a message over the at least one communication network to the further user terminal inviting installation of the client application on the further user terminal.

### BACKGROUND

Some communication systems allow the user of a device, such as a personal computer, to conduct voice or video calls over a packet-based computer network such as the Internet as well as conventional circuit switched networks such as GSM and PSTN communication networks. Such communication systems include voice or video over internet protocol (VoIP) systems. These VoIP systems are beneficial to the user as they are often of significantly lower cost to use than the conventional fixed line (PSTN) or mobile cellular (GSM) networks. This may particularly be the case for long-distance communication. To use a VoIP system, the user installs and executes client software on their device. The client software sets up the VoIP connections as well as providing other functions such as registration and authentication. In addition to voice communication, the client may also set up connections for other communication media such as instant messaging (“IM”), SMS messaging, file transfer and voicemail.

With increasing mobile bandwidths, there is increasing interest in providing packet-based voice and video calls via client applications running on mobile devices such as Internet-enabled mobile phones. These mobile devices comprise transceivers such as short-range RF transceivers operating on one or more unlicensed bands for accessing the Internet via wireless access points (e.g. of Wi-Fi access points of WLAN networks), and/or cellular transceivers operating on one or more licensed bands for accessing the Internet via a packet-based service of a cellular network such as GPRS (General Packet Radio Service) or HSPA (High Speed Packet Access).

### SUMMARY

The inventors have recognised that known client applications consumes a large amount of processor resource (e.g. processor cycles) when a user navigates through a user interface provided by the particular client application. This in turn increases the power consumption of the computing device, which is particularly problematic when the computing device is a mobile device with a limited battery life.

Embodiments of the present disclosure relate to a combined search/invite mechanism provided by a communication client application that enables a user of a user terminal access to search results and an option to invite a user associated with a search result to install the communication client application so that at a later time a call may be placed between the users using the communication client application. This reduces the amount of navigation through the user interface provided by the communication client application that would otherwise be incurred by a user when a separate contact search and invitation procedure must be conducted by the user. This advantageously reduces the amount of processor resource that is incurred when the user navigates through the user interface provided by the communication client application.

According to a first aspect of the present disclosure there is provided a user terminal comprising: a display; one or more processors configured to run a communication client application for establishing communication with at least one further user terminal over at least one communication network, wherein the communication client application is configured to: identify based on at least one search performed by the communication client application at least one search result that is to be displayed on the display, each search result associated with a further user terminal; determine for each of the at least one search result, whether the further user terminal comprises the communication client application; and display the at least one search result on the display, and for each further user terminal not comprising the communication client application, the communication client application is configured to further display a selectable input on the display enabling transmission of a message over the at least one communication network to the further user terminal inviting installation of the communication client application on the further user terminal.

According to another aspect of the present disclosure there is provided a method implemented by a communication client application when executed on a user terminal, the method comprising: identifying based on at least one search performed by the communication client application at least one search result that is to be displayed on a display of the user terminal, each search result associated with a further user terminal; determining for each of the at least one search result, whether the further user terminal comprises the communication client application; and displaying the at least one search result on the display, and for each further user terminal not comprising the communication client application, further displaying a selectable input on the display enabling transmission of a message over at least one communication network to the further user terminal inviting installation of the communication client application on the further user terminal.

According to another aspect of the present disclosure there is provided a computer program product, the computer program product comprising communication client application code embodied on a non-transient computer-readable medium and configured so as when executed on a processor of a user terminal to: identify based on at least one search performed by execution of the communication client application code at least one search result that is to be displayed on a display of the user terminal, each search result associated with a further user terminal; determine for each of the at least one search result, whether the further user terminal comprises the communication client application; and display the at least one search result on the display, and for each further user terminal not comprising the communication client application, further display a selectable input on the display enabling transmission of a message over at least one communication network to the further user terminal inviting installation of the communication client application on the further user terminal.

This summary is provided to introduce a selection of concepts in a simplified form that are further described below in the detailed description. This summary is not intended to identify key features or essential features of the claimed subject matter, nor is it intended to be used to limit the scope of the claimed subject matter. Nor is the claimed subject matter limited to implementations that solve any or all of the disadvantages noted in the background section.

### BRIEF DESCRIPTION OF THE DRAWINGS

For a better understanding of the present invention and to show how it may be put into effect, reference is now made by way of example to the accompanying drawings in which:

FIG. 1 is a schematic representation of a communication system,

FIG. 2 is a schematic block diagram of a mobile terminal,

FIG. 3 which is a flow chart for a process performed by a communication client application executed on the mobile terminal;

FIGS. 4a and 4b illustrates the mobile terminal displaying a search window in a user interface provided by the communication client application; and

FIG. 5 illustrates the mobile terminal displaying an invite window in the user interface provided by the communication client application.

### DETAILED DESCRIPTION

Embodiments of the present disclosure are described by way of example only.

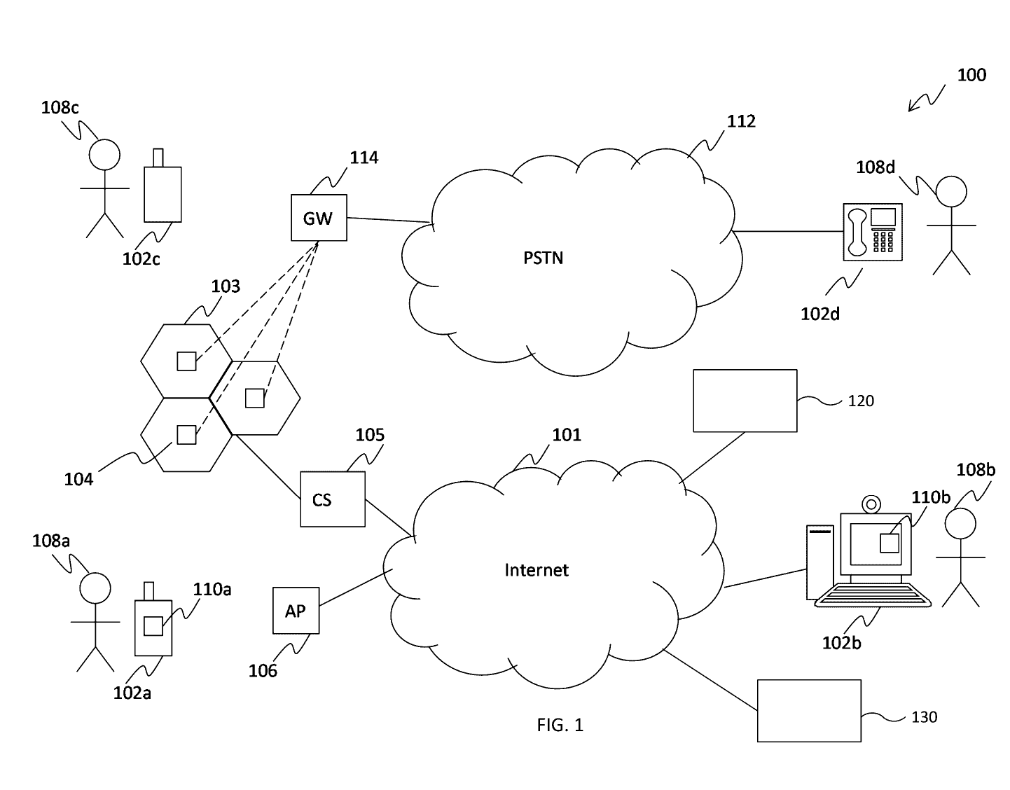

FIG. 1 is a schematic illustration of a communication system 100 comprising a packet-based network 101 such as the Internet, a mobile cellular network 103, and a circuit switched network 112 such as the public switched telephone network (PSTN). The mobile cellular network 103 comprises a plurality of base stations 104 (sometimes referred to as node Bs in 3GPP terminology). Each base station 104 is arranged to serve a corresponding cell of the cellular network 103. Each base station 104 is connected to the circuit switched network 112 via a gateway 114. Further, the packet-switched network 101 comprises a plurality of wireless access points 106 such as Wi-Fi access points for accessing the Internet. These may be the access points of one or more wireless local area networks (WLANs).

A plurality of user terminals 102 (each associated with a respective user 108a-108d) are arranged to communicate over one or more of the networks 101,103,112. For merely illustration purposes only, FIG. 1 shows user terminal 102a as an Internet-enabled mobile device, user terminal 102b as a desktop or laptop PC, user terminal 102c as a cellular mobile phone 102c, and user terminal 102d as a landline telephone connected to the circuit switched network 112.

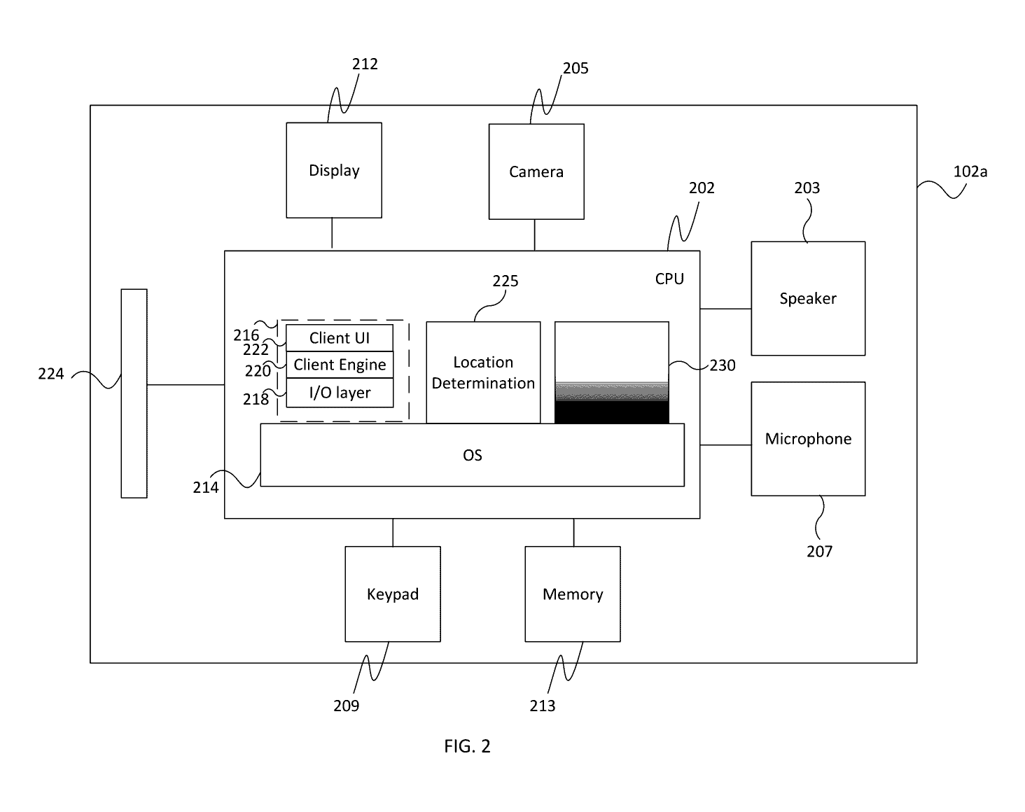

An example user terminal 102a is shown schematically in FIG. 2. The user terminal 102a may be one of an Internet-enabled mobile telephone; a handheld game console; a personal digital assistant (PDA); a tablet computer; or a laptop computer.

The user terminal 102a comprises a processing apparatus in the form of one or more processor units (CPUs) 202 coupled to a memory 213 storing communication client application code. The processor 202 is also coupled to: a microphone 207, a speaker 203, camera 205, a keypad 209, a display 212 and a network interface 224.

In the example shown in FIG. 2, the microphone 207, speaker 203, camera 205, keypad 209, and display 212 are examples of suitable user interface inputs and outputs. In some embodiments the user interface input may be a keyboard, mouse, pointing device, touchpad or any suitable user interface input device, for example gesture or motion control user input, head-tracking or eye-tracking user input, a ‘touch’ or ‘proximity’ detecting input configured to determine the proximity of the user to the display 212 (in other words a touch or hover touch interface).

The network interface 224 enables the user terminal 102a to access the one or more networks 101,103,112. For example, the user terminal 102a may comprise a cellular wireless transceiver for accessing the mobile cellular network 103 via the base stations 104, and/or a wired or wireless modem for accessing the Internet 101. In the case of a wireless modem, this typically comprises a short-range wireless transceiver (e.g. Wi-Fi) for accessing the Internet 101 via the wireless access points 106. For example in some embodiments the network interface 244 may enable initiation of packet based communication with a communication client application on another user terminal over the communication network (such as the internet network 101, or using an overlay network, or a tunneling network through the mobile cellular network 103, or a network distinct from the communication system 100).

Access to the Internet 101 may also be achieved by other means such as GPRS (General Packet Radio Service) or HSPA (High Speed Packet Access). At a higher level of the cellular hierarchy, the cellular network 103 comprises a plurality of cellular controller stations 105 each coupled to a plurality of the base stations 104. The controller stations 105 are coupled to a traditional circuit-switched portion of the mobile cellular network 103 but also to the Internet 101. The controller stations 105 are thus arranged to allow access to packet-based communications via the base stations 104, including access to the Internet 101. The controller stations 105 may be referred to for example as Base Station Controllers (BSCs) in GSM/EDGE terminology or Radio Network Controllers (RNCs) in US™ or HSPA terminology.

The memory 213 may comprise a non-volatile memory such as an electronic erasable and programmable memory (EEPROM, or “flash” memory) coupled to the CPU 202. The memory 213 stores communications code arranged to be executed on the processor, and configured so as when executed to engage in communications over one or more networks 101,103,112. The communications code preferably comprises a communication client application 110a provided by a software provider associated with the communication system. The communication client application 110a is executed for performing packet based communications with other user terminals 102 over at least the Internet 101 via the network interface 224 and wireless access points 106. The communication events which can be established by the communication client application 110a may include one or any combination of voice calls, video calls, instant messages, voice mail, file transfer etc.

The microphone 207, speaker 203, camera 205, keypad 209, display 212 and network interface 224 may be integrated into the user terminal 102 as shown in FIG. 2. In alternative user terminals one or more of the microphone 207, speaker 203, camera 205, keypad 209, display 212 and network interface 224 may not be integrated into the user terminal 102 and may be connected to the CPU 202 via respective interfaces. One example of such an interface is a USB interface.

As shown in FIG. 1 both user terminals 102a and 102b execute communication client application software 110 in order for the user terminals 102a and 102b to transmit and receive data over the Internet 101. In other words the communication client application may be used to initiate packet based communication with another communication client application associated with the same communication network (which may for example be an overlay network or be distinct from the communication system 100). The communication client application may for example be configured to transmit and receive data associated with a defined communication protocol to define the ‘network. For example the communication client application may be configured to communicate with other communication client applications executed on further user terminals using a Voice over Internet Protocol (VoIP) protocol.

It is understood that in some embodiments a user terminal comprises some other client communication software, for example client communication software able to communicate over only one of the communication networks. The communication client application 110 may be downloaded and installed from a remote server. Furthermore in some embodiments the communication client application 110 when first installed or executed may be configured to contact and register the installation or execution of the communication client application at a communication client application database. The communication client application database may comprise parts which are locally cached on the user terminal 102, or remote from the user terminal (for example on a server 120 shown in FIG. 1 or over a distributed computing system).

FIG. 2 also illustrates an operating system (“OS”) 214 executed on the CPU 202. Running on top of the OS 214 is a software stack 216 for the communication client application 110a. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the device 102a and handles the transmission and receipt of data via the network interface 224. The client protocol layer 218 of the communication client application communicates with the operating system 214 and manages the connections over the communication system. Processes requiring higher level processing are passed to the client engine layer 220. The client engine 220 also communicates with the client user interface layer 222. The client engine 220 may be arranged to control the client user interface layer 222 to present information to a user 108a via a user interface of the communication client application 110a and to receive information from the user 108a via the user interface.

Also shown in FIG. 2 is a further communication client application 230. The further communication client may be a native communication client (the communication client provided with the user terminal 102a from the factory). The further communication client may thus be executed for performing communications such as voice or video calls with other user terminals 102 over the network interface 224, base stations 104 and controller stations 105 of the cellular network 103 as discussed above.

Although the user 108a may be able to make or place a call using the communication client application 110a, there may be situations where this is not possible. For example where the other user terminal is not equipped with the communication client application 110 and is only equipped with the native communication client or with another communication client.

A location determination module 225 may also run on top of the OS 214 which is operable to determine the location of the user terminal 102a. The location determination module 225 uses geographic location technology for determining the location of the user terminal 102a, in terms of geographic position relative to the surface of the earth; for example, a satellite based positioning system such as GPS (Global Positioning System, including potential variants such as assisted GPS or differential GPS), GLONASS (Global Navigation Satellite System) or Galileo; and/or trilateration (or more generally muiltilateration) relative to a plurality of different wireless base stations or access points having known locations; and/or a technique based on detecting signal strength relative to a known base station or access point. Other well-known methods may be used for the user terminal 102a to determine its location.

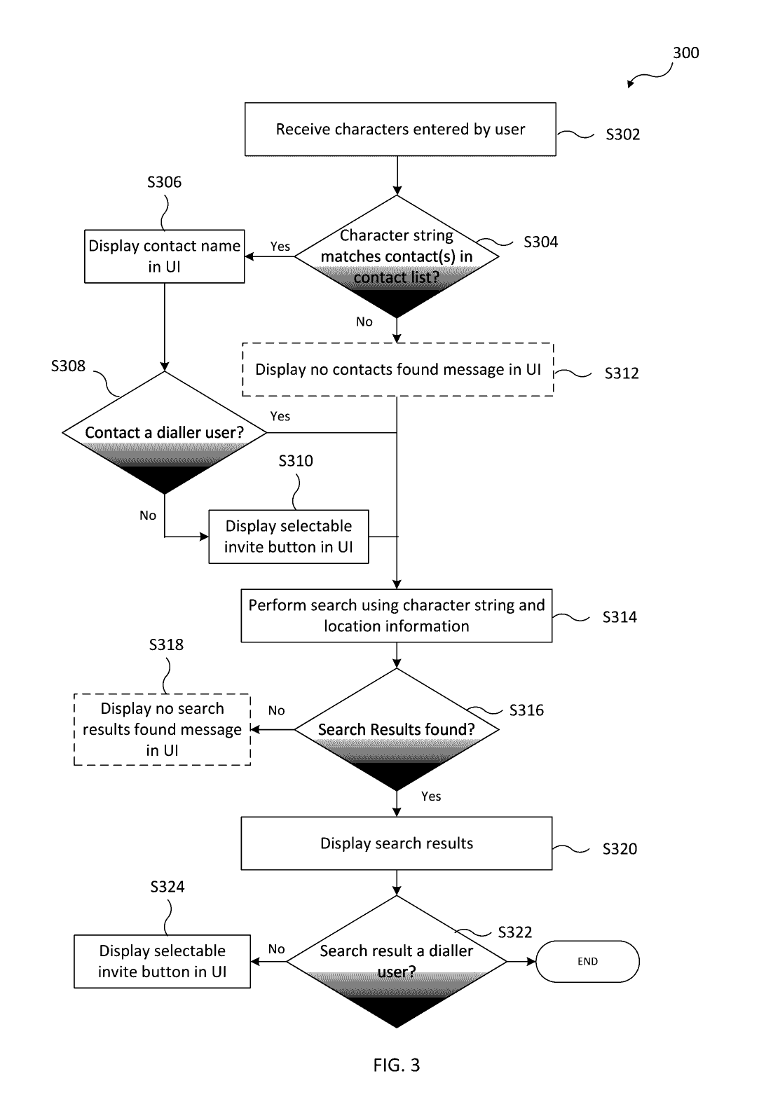

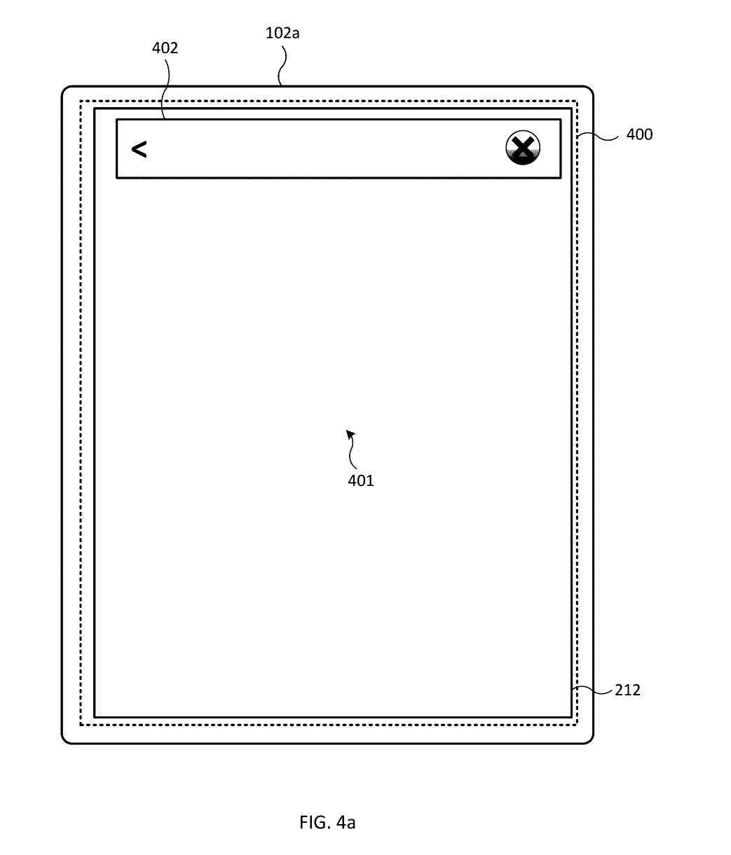

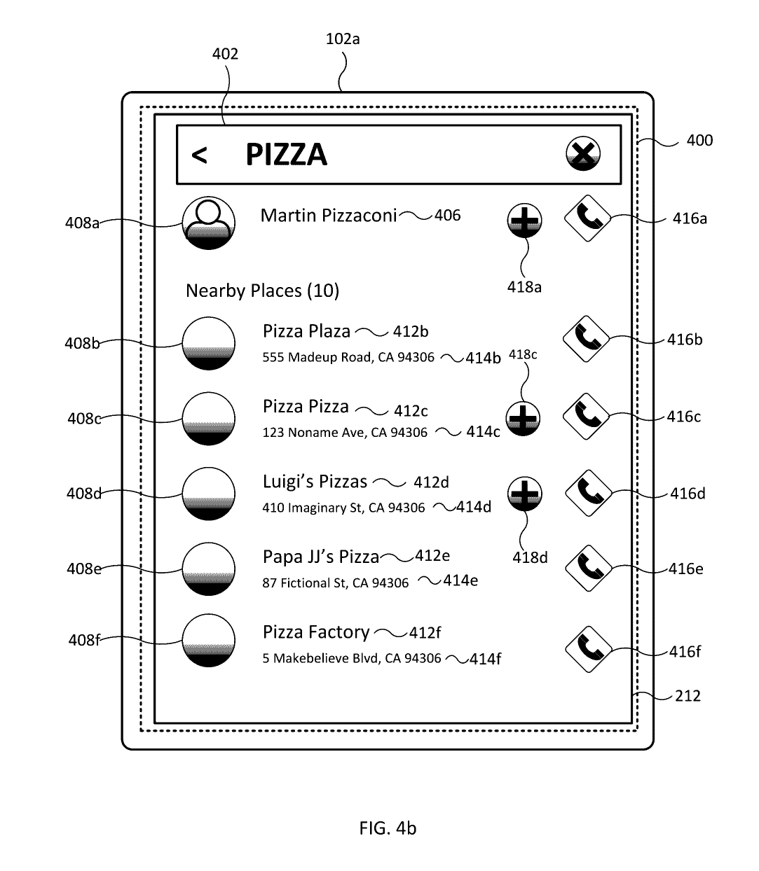

Reference is now made to FIG. 3 which is a flow chart for a process 300 performed by the communication client application 110a executed on user terminal 102a. Reference will also be made to FIGS. 4a and 4b which illustrates an exemplary user interface provided by the communication client application 110a as part of the process 300.

The communication client application 110a is operable to display via the client user interface a search window 401 on display 212 which is illustrated in FIG. 4a. The user 108a may navigate to the search window 401 using an appropriate input device such as a mouse (not shown in FIG. 2), keypad 206, using the touch screen 204, making a voice command to the microphone 207, or using another input device of the user terminal 102a.

The search window 401 comprises an entry field 402 into which user 108a is able to enter text using for example the touch screen 204 or keypad 206.

At step S302 the communication client application 110a receives at least one alphanumeric character entered into the entry field 402 by user 108a.

A contact list stored on memory 213 on the user terminal 102a comprises a list of contact names identifying real life persons that user 108a has stored contact information for. Contact information is associated with each of the contact names in the contact list. Contact information may include for example a landline telephone number, cellular telephone number, fax number, email address, postal address, website etc.

As part of the installation process of communication client application 110a on user terminal 112a described above, the communication client application 110a is configured to perform a search of the remote communication client application database storing telephone numbers associated with users of the communication client application to determine which contact names in the contact list are users of the communication client application and flag these contact names as users of the communication client application.

A search of the communication client application database is performed by the communication client application 110a by transmitting one or more search requests to the remote communication client application database. A search request may comprise one or more telephone numbers associated with contact names in the contact list.

The communication client application database, having received the search request, can be configured to look up the telephone number(s) in the search input to determine whether or not the telephone number(s) are associated with the communication client application. The communication client application database may be configured to generate a suitable search response comprising a flag indicating whether or not the telephone number(s) are associated with the communication client application. The search response is then transmitted from the communication client application database to the communication client application 110a.

The communication client application 110a may then be configured to determine whether or not the search response comprises the flag indicating whether the telephone number(s) are associated with devices which have the communication client application installed. In other words the communication client application performs a test or check of whether there is a positive response that the telephone number(s) are on the communication client database and flags contact names as users of the communication client application in the contact list appropriately.

The communication client application 110a may be further configured to perform periodic searches of the remote communication client application database to ensure that the information (e.g. flags) on users of the communication client application in the contact list is up-to date.

At step S304, the communication client application 110a searches the contact list stored in memory 213 on the user terminal 102a to determine if one or more contact names stored in the contact list comprises the character string received at step S302.

If the communication client application 110a determines at step S304 that one or more contact names stored in the contact list comprise the character string received at step S302, the process 300 proceeds to step S306. At step S306, the communication client application 110a displays contact list search result(s) in an area of the search window 401 whereby each contact list search result comprises a contact name which includes the character string received at step S302.

At step S306, the communication client application 110a is configured to display a predetermined number of contact names as contact list search results in the search window 401. This predetermined number may be 5, however it will be appreciated that this is merely an example. This predetermined number is determined by the provider of the communication client application 110a. The displayed contact list search results may be displayed in list form with the results arranged in alphabetical order.

If the contact list comprises more than the predetermined number of contact names that comprise the character string received at step S302, the communication client application 110a is configured to display these further contact names as contact list search results in response to a user input received from the user 108a. The user input may be for example be a finger swipe gesture on an area of the display 204 (a touch screen) that has been made by user 108a using their finger or other computing instrument used to input a command to the touch screen (such as a stylus) to scroll through the contact list search results.

Alongside each of the contact names, the communication client application 110a may additionally display an avatar (a static image chosen by a user to represent themselves) associated with the contact name. The avatar may be stored in memory 213 as part of the contact list information or may be pulled from an external network entity connected to network 101 storing social media data if user 108a has established a social media connection with the person identified by the contact name. If no avatar is associated with the contact name a default avatar image stored in memory 213 may be used.

Alongside each of the contact names, the communication client application 110a displays a selectable call button that enables a call (e.g. voice or video call) to be established to a device associated with the person (or company, institution, service etc.) identified by the contact name.

At step S308, the communication client application 110a determines for each of the contact names displayed at step S306 whether the person identified by the contact name is a user of the communication client application (in other words whether the person is associated with an apparatus or a device which is also executing the communication client application).

Step S308 may comprise the communication client application 110a performing a local search of the contact list stored in memory 213 to determine whether each contact name is flagged as a communication client user. Alternatively or additionally, step S308 may comprise the communication client application 110a performing a search of the remote communication client application database by transmitting one or more search requests to the remote communication client application database and receiving search response(s) from the remote communication client application database to determine whether each contact name is flagged as a user of the communication client application.

For each of the contact names displayed at step S306, a separate search request comprising a telephone number associated with the contact name may be transmitted to the remote communication client application database. Alternatively, a search request comprising telephone numbers associated with multiple contact names displayed at step S306 may be transmitted to the remote communication client application database.

If a contact name is not a user of the communication client application, the process 300 proceeds to step S310 whereby the communication client application 110a displays, alongside the contact name, a selectable invite button that enables an invite message to be transmitted to the device associated with the person identified by the contact name. This invite message is described in more detail below. The process then proceeds to step S314.

As shown in FIG. 3, if the communication client application 110a determines at step S308 that a person identified by a contact name is a user of the communication client application, the process 300 proceeds directly to step S314 without the communication client application 110a displaying a selectable invite button alongside the contact name.

Referring back to step S304, if the communication client application 110a determines that the contact list does not comprise a contact name that comprises the character string received at step S302, the process 300 may proceed to an optional step S312 whereby the communication client application 110a displays a message in an area of the search window 401 indicating that no matching contacts have been found. Alternatively step 312 is not performed (no indication that no matching contacts have been found is displayed) and the process 300 proceeds to step S314.

FIG. 4b illustrates the search window 401 following entry of the text “PIZZA” in the entry field 402 by user 108a in a scenario whereby the contact list stored in memory 213 on the user terminal 102a comprises a contact name “Martin Pizzaconi” who is not a user of the communication client application.

As shown in FIG. 4b, due to the contact name “Martin Pizzaconi” comprising the text “PIZZA” the communication client application 110a displays the contact name “Martin Pizzaconi” 406 as a contact list search result in an area of the search window 401 as a result of step S306.

Alongside the contact name 406, a selectable call button 416a is displayed enabling user 108a to establish a call to a device associated with the person identified by the contact name. FIG. 4b further illustrates a selectable invite button 418a displayed alongside the contact name 406, that enables an invite message to be transmitted to the device associated with the person identified by the contact name 406, as a result of step S310.

Whilst the process 300 shows the communication client application 110a displaying contact list search results in the search window 401 and then updating the search window 401 by displaying selectable invite button(s) (if appropriate), in other embodiments the communication client application 110a may delay the display of the contact list search results until the communication client application 110a has determined whether the person identified by each contact name that is to be displayed is a user of the communication client application such that the contact list search results and selectable invite button(s) (if appropriate) may be displayed in the search window 401 at the same time.

At step S314, the communication client application 110a performs a search using the character string received at step S302 and the location of the user terminal 102a.

The communication client application 110a may determine the location of the user terminal 102 based on location information (e.g. latitude/longitude information) received from the location determination module 225 in response to transmitting a request for location information to the location determination module 225.

Alternatively, the communication client application 110a may determine the location of the user terminal 102a based on an indication of the location of the user terminal 102 selected or entered by user 108a. For example, user 108a may manually enter his location in the user interface provided by the communication client application 110a. In another example, user 108a may select an online presence status or enter a mood message in the user interface provided by the communication client application 110a that provides an indication of the user's location (e.g. indicates that he is in a particular city, state or country).

Step S314 comprises the communication client application 110a transmitting a search request comprising the character string received at step S302 and the location of the user terminal 102a, to a network entity (e.g. web server) 130 coupled to the network 101. The web server 130 is configured to execute web search engine software to search for content on the World Wide Web. An exemplary search engine is the Bing™ search engine provided by Microsoft®.

The web server 130 is configured to return search results of names of points of interest (e.g. places of interest which may for example be a school, restaurant, hotel, garage, or other company etc.) in the vicinity of the user terminal 102a based on the character string and the location information which user 108a may establish communication with. For example using an application programming interface (API) e.g. Microsoft Bing Points of Interest API, enables the web server 130 to search a database in the network 101 storing points of interest and their associated location information based on the search request.

The web server 130 is configured to return search results in a response transmitted to the user terminal 102a. The web server 130 assigns a ranking to each of the search results. This ranking is determined by the particular algorithm executed by the web server 130 and may be based on for example, the relevance of the point of interest to the character string, the distance of the point of interest to the user terminal 102a, and/or the prominence of the point of interest.

In addition to the name of the point of interest, the web server 130 may return additional information associated with the point of interest. The additional information associated with the point of interest comprises contact information e.g. a PSTN telephone number or mobile telephone number that enables user 102a to place a call to the point of interest. Other contact information may include postal address, email address, website etc.

At step S316, the communication client application 110a determines whether any search results have been found by the web server 130 based on analysing the response received from the web server 130.

If the communication client application 110a determines at step S316 that no search results have been found by the web server 130 the process 300 may proceed to an optional step S318 whereby the communication client application 110a displays a message in an area of the search window 401 indicating that no search results have been found. Alternatively step S318 is not performed (no indication that no matching contacts have been found is displayed) and the process 300 ends.

If the communication client application 110a determines at step S316 that one or more search results have been found by the web server 130 the process 300 proceeds to step S320. At step S320 the communication client application 110a displays a predetermined number of the point of interest names as search results in an area of the search window 401. This predetermined number may be 10, however it will be appreciated that this is merely an example. This predetermined number is determined by the provider of the communication client application 110a. The displayed search results may be displayed in list form with the results arranged in an ascending order of ranking assigned by the web server 130 (the highest ranking search result displayed at the top of the list).

If the web server response comprises more than the predetermined number of points of interest, the communication client application 110a is configured to display these further search results in response to a user input received from the user 108a. The user input may be for example be a finger swipe gesture on an area of the display 204 (a touch screen) that has been made by user 108a using their finger or other computing instrument used to input a command to the touch screen (such as a stylus) to scroll through the web server search results.

If the communication client application 110a determines at step S316 that one or more search results have been found by the web server 130 the communication client application 110a may store the returned search results in memory 213 for future searches using the same character string made at the same location to obtain the one or more search results faster due to not having to communicate with the web server 130.

At step S322, the communication client application 110a determines for each of the points of interest displayed at step S306 whether the point of interest is a user of the communication client application (in other words whether the point of interest is associated with an apparatus or a device which is also executing the communication client application).

Step S322 may comprise the communication client application 110a performing a search of the remote communication client application database by transmitting one or more search requests to the remote communication client application database and receiving search response(s) from the remote communication client application database to determine whether each point of interest is flagged as a user of the communication client application.

For each of the points of interest displayed at step S320, a separate search request comprising telephone number(s) associated with the points of interest (extracted from the contact information associated with the point of interest returned by the web server 130) may be transmitted to the remote communication client application database. Alternatively, a search request comprising telephone numbers associated with multiple points of interest displayed at step S320 may be transmitted to the remote communication client application database.

The additional information associated with a point of interest returned to the communication client application 110a by the web server 130 may comprise an indicator indicating that the device associated with the particular point of interest comprises the communication client application. Thus at step S322, the communication client application 110a may be configured to determine for each of the points of interest displayed at step S320 whether the point of interest is a user of the communication client application based on whether the additional information associated with the point of interest comprises the indicator. If the communication client application 110a determines that a point of interest is a user of the communication client application based on the additional information associated with the point of interest comprising the indicator, then a search of the remote communication client application database for this point of interest is not required.

If a point of interest is not a user of the communication client application, the process 300 proceeds to step S324 whereby the communication client application 110a displays, alongside the name of the point of interest, a selectable invite button that enables an invite message to be transmitted to the device associated with the point of interest. This invite message is described in more detail below.

As shown in FIG. 3, if the communication client application 110a determines at step S322 that a point of interest is a user of the communication client application, the process 300 ends without the communication client application 110a displaying a selectable invite button alongside the web server 130 search result.

In the process 300 described above, the communication client application 110a may perform step S314 only if the character string received at step S302 comprises at least a predetermined number of alphanumeric characters. This predetermined number of alphanumeric characters may be 3, however it will be appreciated that this is merely an example. This predetermined number is determined by the provider of the communication client application 110a. Similarly, the communication client application 110a may perform the search of the contact list stored in memory 213 at step S304 only if the character string received at step S302 comprises at least a predetermined number of alphanumeric characters. This predetermined number of alphanumeric characters may be 3, however it will be appreciated that this is merely an example. This predetermined number is determined by the provider of the communication client application 110a.

FIG. 4b illustrates the search window 401 comprising a plurality of point of interest names 412b-f displayed as search results that are returned to the communication client application 110a by the web server 130 in response to the search request transmitted to the web server 130 comprising the text “PIZZA” and the location information of the user terminal 102a. The communication client application 110a receives search results about the “Pizza” places geographically located close to the location of the user terminal 102a. That is, the plurality of search results 412b-f returned to the communication client application 110a are points of interest relating to the search term “Pizza”.

FIG. 4b illustrates a first point of interest “Pizza Plaza” 412b, a second point of interest “Pizza Pizza” 412c, a third point of interest “Luigi's Pizzas” 418d, a fourth point of interest “Papa JJ's Pizza” 412e and a fifth point of interest “Pizza Factory” 412f being displayed as search results in an area of the search window 401 as a result of step S320. Alongside each of the point of interest names 412b-f, a selectable call button 416b-f is displayed enabling user 108a to establish a call to a device associated with the point of interest using the contact information associated with the point of interest returned by the web server 130.

In a scenario whereby the communication client application 110a has determined that points of interest “Pizza Pizza” 412c and “Luigi's Pizzas” 418d are not users of the communication client application at step S322, as shown in FIG. 4b the communication client application 110a displays a selectable invite button 418 displayed alongside the respective point of interest name 412, that enables an invite message to be transmitted to the device associated with the point of interest, as a result of step S324.

Whilst the process 300 shows the communication client application 110a displaying names of points of interest as search results in the search window 401 and then updating the search window 401 by displaying selectable invite button(s) (if appropriate), in other embodiments the communication client application 110a may delay the display of the web server search results until the communication client application 110a has determined whether each of the points of interest that are to be displayed is a user of the communication client application such that the web server search results and selectable invite button(s) (if appropriate) may be displayed in the search window 401 at the same time.

A selectable invite button 418 displayed by the communication client application 110a enables user 108a of user terminal 102a to select and to notify and invite the other party to install the communication client application.

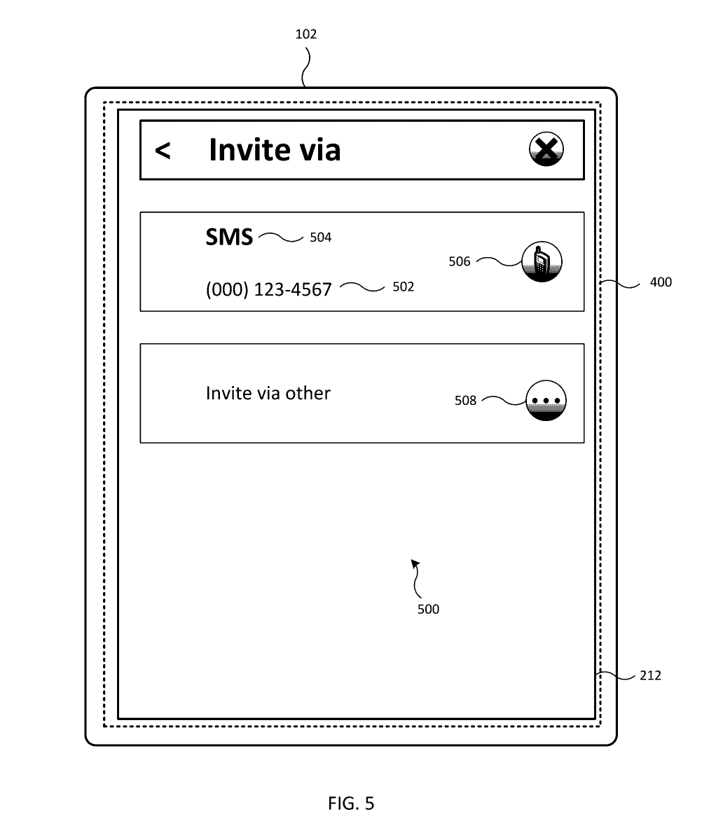

FIG. 5 shows an example invite window 500 displayed on the display 212 by the communication client application 110a in response to detecting selection of a selectable invite button 418. User 108a may select a selectable invite button 418 using an input device of the user terminal 102a such as the display 212 (if the display is a touch screen), keypad 209, or mouse (not shown in FIG. 2).

The invite window 500 may for example show the bearer information 504 (in this example SMS) indicating which communication medium over which the invite is to be sent, a telephone number 502 of the recipient party, a UI interaction element 506 to confirm the sending of an invite message, and an alternative bearer selector 508 to select a different bearer (e.g. email, multimedia message, instant messenger message, chat message etc.) to send the invite message. A “bearer” may be any suitable method for communicating communication client application installation invites to the user terminal of the recipient party.

In response to detecting selection of the UI interaction element 506, the communication client application 110a is configured to generate an invite message and transmit the generated invite message via the network interface 224 and the suitable bearer to the recipient party.

The invite message may be combination of text e.g. ‘Do you want to use communication client application, I am!’ and a URL identifying an address of a network storage location storing installation files for the communication client application and other information.

The recipient party upon receiving the invite message from the user terminal 102a may select the URL in the invite message to initiate installation of the communication client application 110a for example from an app store.

In other embodiments, in response to detecting selection of a selectable invite button 418, the communication client application 110a is configured to generate an invite message and transmit the generated invite message via the network interface 224 over a bearer deemed suitable by the communication client application 110a to the recipient party without further input from user 108a.

The process 300 performed by the communication client application 110a executed on user terminal 102a advantageously allows user 108a to identify whether a packet-based communication can be placed to an endpoint that has been discovered via an internet search. Furthermore, the process 300 enables user 108a to invite endpoints that have been discovered via the internet search but which are unable to conduct packet-based communication, to install the communication client application so that at a later time communication events may be placed between user 108a and the endpoint using packet-based communication via use of the communication client application.

The steps shown separately in FIG. 3 may or may not be implemented as separate steps. Furthermore embodiments of the present disclosure are not limited to the communication client application 110 performing the steps in the order shown in FIG. 3. For example whilst FIG. 3 shows the communication client application 110a performing the contact list search and then subsequently performing the search for web content, these searches may be implemented in a different order or in parallel.

Furthermore, whilst FIG. 3 shows the communication client application 110a performing both the contact list search (steps S304-S312) and the search for web content (steps S314-S324). In one embodiment of the present disclosure the communication client application 110a is configured to only perform the contact list search (steps S302, S304-S312). In another embodiment of the present disclosure the communication client application 110a is configured to only perform the search for web content (steps 302, S314-S324).

FIGS. 4a and 4b shows the client user interface provided by the communication client application 112 displaying content in an available area 400 of the display 212. As depicted in FIGS. 4a and 4b, the available area 400 of the display 212 is the whole of the display. However, it is envisaged that the available area of the display (that is the area available to the communication client application 110a) may constitute only a portion of the display e.g. with the remainder of the display being used by the OS 214 and/or other application(s) executed thereon to display other content.

Generally, any of the functions described herein can be implemented using software, firmware, hardware (e.g., fixed logic circuitry), or a combination of these implementations. The terms “controller”, “module”, and “application” as used herein generally represent software, firmware, hardware, or a combination thereof. In the case of a software implementation, the controller, module or application represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

As described above according to a first aspect of the present disclosure there is provided a user terminal comprising: a display; one or more processors configured to run a communication client application for establishing communication with at least one further user terminal over at least one communication network, wherein the communication client application is configured to: identify based on at least one search performed by the communication client application at least one search result that is to be displayed on the display, each search result associated with a further user terminal; determine for each of the at least one search result, whether the further user terminal comprises the communication client application; and display the at least one search result on the display, and for each further user terminal not comprising the communication client application, the communication client application is configured to further display a selectable input on the display enabling transmission of a message over the at least one communication network to the further user terminal inviting installation of the communication client application on the further user terminal.

The communication client application may be configured to perform a remote search by transmission of a search request comprising a search term input by a user associated with the user terminal and an indication of a geographical location of the user terminal over the at least one communications network to a network entity configured to perform a search for web content.

The user terminal may further comprise a location determination module operable to determine said geographical location of the user terminal and supply the indication of the geographical location of the user terminal to the communication client application.

In response to receiving one or more remote search results from the network entity, the communication client application may be configured to identify a predetermined number of the one or more remote search results that are to be displayed on the display.

For each of the predetermined number of remote search results, the communication client application may be configured to determine whether the further user terminal comprises the communication client application based on whether contact information of the further user terminal obtained from said remote search comprises an indicator indicating that the further user terminal comprises the communication client application.

For each of the predetermined number of remote search results, the communication client application may be configured to: extract an identifier identifying the further user terminal from contact information of the further user terminal obtained from said remote search; transmit a search request comprising the identifier over the at least one communications network to a network entity comprising a communication client application database; receive a response to the search request, the response comprising an indication as to whether the further user terminal comprises the communication client application; and determine whether the further user terminal comprises the communication client application based on said response.

The user terminal may comprise a memory, and the communication client application may be configured to store the remote search results received from the network entity in said memory.

The communication client application may be configured to perform said remote search if the search term comprises at least a predetermined number of alphanumeric characters.

The user terminal may comprise a memory storing a contact list associated with the user of the user terminal, and the communication client application may be configured to perform a local search of said contact list to determine whether the contact list comprises at least one contact name comprising a search term input by a user associated with the user terminal.

In response to determining that at least one contact name in the contact list comprises the search term, the communication client application may be configured to identify a predetermined number of the at least one contact names that are to be displayed on the display as a contact list search result.

For each of the predetermined number of contact list search results, the communication client application may be configured to determine whether the further user terminal comprises the communication client application based on whether information of the further user terminal obtained from said local search comprises an indicator indicating that the further user terminal comprises the communication client application.

For each of the predetermined number of contact list search results, the communication client application may be configured to: extract an identifier identifying the further user terminal from contact information of the further user terminal obtained from said local search; transmit a search request comprising the identifier over the at least one communications network to a network entity comprising a communication client application database; and receive a response to the search request, the response comprising an indication as to whether the further user terminal comprises the communication client application; and determine whether the further user terminal comprises the communication client application based on said response.

In response to detecting selection of a selectable input the communication client application may be configured to transmit the message over the at least one communication network to the further user terminal associated with the selectable input.

In response to detecting selection of a selectable input the communication client application may be configured to display a window comprising a user interface element enabling a user associated with the user terminal to control generation of the message prior to transmission of the message to the further user terminal associated with the selectable input.

The communication client application may be configured to display, for each of the at least one search result, a selectable call button enabling a user associated with the user terminal to establish a call to the further user terminal associated with the search result

The user terminal may be one of: an Internet-enabled mobile telephone; a handheld game console; a personal digital assistant (PDA); a tablet computer; and a laptop computer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A user terminal comprising:
a display;
one or more processors configured to run a communication client application for establishing communication with at least one further user terminal over at least one communication network, wherein the communication client application is configured to:
identify based on at least one search performed by the communication client application, at least one search result that is to be displayed on the display, each search result associated with a further user terminal;
determine for each of the at least one search result, whether the further user terminal comprises the communication client application; and
display the at least one search result on the display, and for each further user terminal not comprising the communication client application, the communication client application is configured to further display a selectable input on the display enabling transmission of a message over the at least one communication network to the further user terminal inviting installation of the communication client application on the further user terminal.

2. A user terminal according to claim 1, wherein the communication client application is configured to perform a remote search by transmission of a search request comprising a search term input by a user associated with the user terminal and an indication of a geographical location of the user terminal over the at least one communications network to a network entity configured to perform a search for web content.

3. A user terminal according to claim 2, wherein the user terminal further comprises a location determination module operable to determine said geographical location of the user terminal and supply the indication of the geographical location of the user terminal to the communication client application.

4. A user terminal according to claim 2, wherein in response to receiving one or more remote search results from the network entity, the communication client application is configured to identify a predetermined number of the one or more remote search results that are to be displayed on the display.

5. A user terminal according to claim 4, wherein for each of the predetermined number of remote search results, the communication client application is configured to determine whether the further user terminal comprises the communication client application based on whether contact information of the further user terminal obtained from said remote search comprises an indicator indicating that the further user terminal comprises the communication client application.

6. A user terminal according to claim 4, wherein for each of the predetermined number of remote search results, the communication client application is configured to:
extract an identifier identifying the further user terminal from contact information of the further user terminal obtained from said remote search;
transmit a search request comprising the identifier over the at least one communications network to a network entity comprising a communication client application database;
receive a response to the search request, the response comprising an indication as to whether the further user terminal comprises the communication client application; and
determine whether the further user terminal comprises the communication client application based on said response.

7. A user terminal according to claim 4, wherein the user terminal comprises a memory, and the communication client application is configured to store the remote search results received from the network entity in said memory.

8. A user terminal according to claim 2, wherein the communication client application is configured to perform said remote search if the search term comprises at least a predetermined number of alphanumeric characters.

9. A user terminal according to claim 1, wherein the user terminal comprises a memory storing a contact list associated with the user of the user terminal, and the communication client application is configured to perform a local search of said contact list to determine whether the contact list comprises at least one contact name comprising a search term input by a user associated with the user terminal.

10. A user terminal according to claim 9, wherein in response to determining that at least one contact name in the contact list comprises the search term, the communication client application is configured to identify a predetermined number of the at least one contact names that are to be displayed on the display as a contact list search result.

11. A user terminal according to claim 10, wherein for each of the predetermined number of contact list search results, the communication client application is configured to determine whether the further user terminal comprises the communication client application based on whether information of the further user terminal obtained from said local search comprises an indicator indicating that the further user terminal comprises the communication client application.

12. A user terminal according to claim 10, wherein for each of the predetermined number of contact list search results, the communication client application is configured to:
extract an identifier identifying the further user terminal from contact information of the further user terminal obtained from said local search;
transmit a search request comprising the identifier over the at least one communications network to a network entity comprising a communication client application database; and
receive a response to the search request, the response comprising an indication as to whether the further user terminal comprises the communication client application; and
determine whether the further user terminal comprises the communication client application based on said response.

13. A user terminal according to claim 1, wherein in response to detecting selection of a selectable input the communication client application is configured to transmit the message over the at least one communication network to the further user terminal associated with the selectable input.

14. A user terminal according to claim 1, wherein in response to detecting selection of a selectable input the communication client application is configured to display a window comprising a user interface element enabling a user associated with the user terminal to control generation of the message prior to transmission of the message to the further user terminal associated with the selectable input.

15. A user terminal according to claim 1, wherein the communication client application is configured to display, for each of the at least one search result, a selectable call button enabling a user associated with the user terminal to establish a call to the further user terminal associated with the search result.

16. The user terminal according to claim 1, wherein the user terminal is one of: an Internet-enabled mobile telephone; a handheld game console; a personal digital assistant (PDA); a tablet computer; and a laptop computer.

17. A method implemented by a communication client application when executed on a user terminal, the method comprising:
identifying based on at least one search performed by the communication client application, at least one search result that is to be displayed on a display of the user terminal, each search result associated with a further user terminal;
determining for each of the at least one search result, whether the further user terminal comprises the communication client application; and
displaying the at least one search result on the display, and for each further user terminal not comprising the communication client application, further displaying a selectable input on the display enabling transmission of a message over at least one communication network to the further user terminal inviting installation of the communication client application on the further user terminal.

18. The method according to claim 17, comprising performing a remote search by transmission of a search request comprising a search term input by a user associated with the user terminal and an indication of a geographical location of the user terminal over the at least one communications network to a network entity configured to perform a search for web content.

19. The method according to claim 17, comprising performing a local search of a contact list stored in a memory of the user terminal to determine whether the contact list comprises at least one contact name comprising a search term input by a user associated with the user terminal.

20. A computer program product, the computer program product comprising communication client application code embodied on a computer-readable medium and configured so as when executed on a processor of a user terminal to:
identify based on at least one search performed by execution of the communication client application code, at least one search result that is to be displayed on a display of the user terminal, each search result associated with a further user terminal;
determine for each of the at least one search result, whether the further user terminal comprises the communication client application;
display the at least one search result on the display, and for each further user terminal not comprising the communication client application, further display a selectable input on the display enabling transmission of a message over the at least one communication network to the further user terminal inviting installation of the communication client application on the further user terminal.
